(19) United States
(12) Patent Application Publication
(10) Pub. No.: US 2026/0352254 A1
(43) Pub. Date: Nov. 5, 2026

(54) Signaling for Cooperative DPOD

(71) Applicant: Telefonaktiebolaget LM Ericsson (publ), Stockholm (SE)

(72) Inventors: Andres Reial, Lund (SE); Sina Maleki, Lund (SE); Ali Nader, Lund (SE); Rickard Ljung, Lund (SE); Henrik Sjöland, Lund (SE); Ryan Padema, Kanagawa (JP)

(21) Appl. No.: 19/486,571

(22) PCT Filed: May 23, 2024
(86) PCT No.: PCT/EP2024/064224

§ 371 Date: Nov. 21, 2025

Related U.S. Application Data
(60) Provisional application No. 63/469,877, filed on May 31, 2023.
(60) Provisional application No. 63/469,979, filed on May 31, 2023.
(60) Provisional application No. 63/469,891, filed on May 31, 2023.

(51) Int. Cl. H04B 1/62; H04B 1/04

(52) U.S. Cl. CPC H04B 1/62; H04B 1/0475; H04B 2001/0425

(57) ABSTRACT

Methods for sending and receiving capability information and/or configuration information regarding digital post-distortion (DPoD) capabilities and/or use. A method, in a first device, comprises sending, to a second device, capability information indicating the first device's ability to perform digital post-distortion (DPoD) processing to reduce non-linear distortion in signals received by the first device. A method, in a second device, comprises receiving, from a first device, capability information indicating the first device's ability to perform digital post-distortion (DPoD) processing to reduce non-linear distortion in signals received by the first device.

### TECHNICAL FIELD

This disclosure is generally related to wireless communications and is more particularly related to techniques for compensating for non-linearities in the transmission of radio signals.

### BACKGROUND

Due to their multicarrier structure, traditional Orthogonal Frequency Division Multiplexing (OFDM) signals have an inherently high peak-to-average-power ratio (PAPR), i.e., a high probability of high instantaneous signal magnitude peaks in relation to the average magnitude of the waveform. This is problematic for power-efficient power amplifier (PA) operations, since the peaks may drive the PA to its non-linear input/output mapping region, which will distort the output by attenuating or clipping the corresponding peaks and causing spectral widening whereby adjacent channel interference is created, degrading the adjacent channel leakage ratio (ACLR). To avoid this, the PA needs to be operated in its shallow linear region so that the peaks do not drive it into the non-linear part of the transfer curve. However, this results in low power efficiency since, on average, a moderate fraction of the full power capability is utilized. Operating with such a PA strategy is costly, since PAs with higher peak power need to be used, and the related energy consumption is also high, since the PAs need to be driven at a higher bias voltage.

Minimizing energy consumption in wireless networks, in both UEs and NW nodes is a necessity for supporting constantly increasing bandwidths and data rates with maintained time between charging. PA energy consumption is a major contributor to both user equipment (UE) and network (NW) energy consumption. Numerous approaches have been used for PAPR reduction, e.g., discrete Fourier Transform-spread OFDM (DFTS-OFDM), crest factor reduction (CFR), tone reservation (TR), digital pre-distortion (DPD) processing, and digital post-distortion (DPoD) processing. Some of these techniques, such as DPD and DPoD, have been proposed as a way for 3rd-generation Partnership Project (3GPP) networks to save energy, particularly in higher-load scenarios.

The basic building blocks of DFTS-OFDM, also referred to as Single Carrier Frequency-Division Multiple Access (SC-FDMA), are illustrated in FIG. 1. As seen in FIG. 1, a baseband input signal, which may be referred to as a “modulation symbol,” e.g., comprising quadrature-phase-shift keying (QPSK), 16-quadrature-amplitude modulation (16 QAM), or 64 QAM modulation symbols, and which may be regarded as being in the frequency-domain (F-domain), with respect to the inverse Fast Fourier Transform (IFFT) operation to be performed later, is input to a discrete Fourier Transform (DFT) operation, to “spread” the input baseband signal across the frequency bins output from the DFT. This is shown in FIG. 1 as the DFTS block. An IFFT operation is then performed on the DFTS block's output. The resulting time-domain signal is then provided to the radio frequency (RF) circuitry, shown as RF FE (front-end)+PA in FIG. 1, for upconversion, amplification, and transmission.

At the receiver end, the reverse processes are performed. After passing through the radio channel, the RF signal is received with a receiver's RF circuitry, shown as LNA (low-noise amplifier)+RF FE in FIG. 1. This block amplifies and downconverts the received radio signal. A Fast Fourier Transform (FFT) is performed, to reverse the IFFT operation performed in the transmitter. Optionally, the output is equalized, to compensate for channel distortions. The DFTS process is reversed, using an inverse DFT. This produces an output signal, again in the “F-domain” with respect to the IFFT and FFT operations, which can be demodulated.

For the purposes of the present disclosure, DFTS-OFDM is regarded as one form of OFDM. Cyclic-prefix OFDM (CP-OFDM), which is used by base stations in LTE networks and which does not include the DFTS step shown in FIG. 1, is another.

Several mitigation approaches may reduce the PAPR or non-linear effects, but each has respective shortcomings. For example, with DFT-spread OFDM, the multi-carrier OFDM signal is converted to single-carrier signal by applying a DFT prior to conversion to the time domain. The resulting signal has a lower PAPR, but the PAPR reduction is moderate and is not robust with respect to channel dispersion. As a consequence, equalization needs to be applied prior to the inverse DFT in the receiver.

Crest factor reduction (CFR) is another example. With CFR, the individual signal peaks are reduced before feeding the signal into the PA, e.g., by soft or hard clipping. Uncontrolled spectral spreading is avoided but considerable signal distortion remains. With tone reservation (TR), another approach, some OFDM subcarriers are reserved and an additive signal component is inserted into the reserved tones, to produce a time-domain contribution that reduces the individual high peaks. However, for a sufficiently strong effect, a large number of reserved tones is required, reducing carrier capacity, and the computation complexity of deriving a suitable additive waveform is high.

Digital pre-distortion (DPD) is another technique. With DPD, the PA input signal is pre-distorted so that the aggregate effect of the pre-distortion and PA distortion is approximately linear. Although overall distortion at the receiver is reduced or eliminated, the PA non-linearity, when relying solely on DPD, can still generate excessive spectral leakage.

Digital-Post Distortion (DPoD), which is a receiver-side technique, can be used to reduce the impact of non-linearity in the PA. DPoD processing is expected to be useful for PA non-linearity mitigation in cellular networks in some scenarios.

In DPoD, the PA output signal is processed on the receiver side to mitigate the effect of PA non-linearity and approximate a sufficiently linear end-to-end characteristic. The inverse (non-linearity removal) processing in the RX may employ an iterative process since the residual non-linearity function may not be known or may not be easily invertible. The approach works preferably in cases where the TX (PA output) and RX (LNA input) signals are exactly the same signals, e.g., when the transmitted signal is a single-layer signal.

### SUMMARY

The DPoD algorithm may be implemented as fully autonomous, but the Applicant has appreciated that coordination and additional information transfer to and/or from the transmitter could further improve the efficiency of the solution. There is thus a need for signaling mechanisms to properly configure and activate DPoD operation at the receiver and align with the transmitting node. Further, estimating the non-linearity of the transmitter's PA is a challenge for the receiver. There is thus a need for signaling mechanisms to support DPoD operation by enabling non-linearity (NL) estimation at the receiver, in alignment with the transmitting node. Further, knowledge of the transmitter operating mode and the current PA regime may help the receiver to adapt its DPoD processing. There is thus a need for signaling mechanisms for the provision of transmitter status information, to support DPoD operation at the receiver, in alignment with the transmitting node.

Embodiments of the techniques, apparatuses, and systems described herein may address these needs, by providing a technique whereby a receiving node in a wireless network, e.g., a UE or a gNB, performs DPoD processing on a received signal to remove or reduce non-linear distortion caused by a transmitting node (e.g., a gNB or a UE, respectively). The techniques described herein provide signaling mechanisms by which the RX and TX nodes may align their operations and whereby the TX node may provide assistance/support information that is useful for the DPoD processing in the RX node. The techniques described herein provide signaling mechanisms by which the receiver (RX) and transmitter (TX) nodes may align their operation in the area of non-linearity estimation (NLE) and by which the TX node may provide a reference signal (RS) that enables improved compensation configuration in the DPoD processing.

Signaling mechanisms for such alignment and assistance may be provided that allow capability and functionality signaling as well as DPoD activation/scheduling, e.g.:
DPoD capability and related assistance capability signaling.
Preference indication by RX at which distortion level it can/would like to operate its DPoD.
Indication that the RX should apply DPoD for receiving signals (DL) or that RX intends to use DPoD for reception of signals (UL).
Signaling of a recommended non-linear model to use for DPoD and/or available parameters or parameter values for such model.

Signaling mechanisms are also presented that enable non-linearity estimation reference signal (NLE-RS) handling, including at least:
non-linearity estimation RS capability signaling;
NLE-RS configuration; and
NLE-RS transmission.

The signaling mechanisms and utilization of such assistance may include at least three aspects:
post-PA NL characteristic information;
other TX status and operating mode provision; and
DPoD adaptation based on PA and TX status.

Uplink (UL) and downlink (DL) versions of relevant signaling are described.

The described techniques may allow the TX side to assist the DPoD solution in the RX. As a result, the DPoD algorithm may be run with improved performance and/or more energy-efficiently. UE and/or network key performance indicators (KPIs), such as throughput, latency, and quality-of-experience (QoE), may thereby, advantageously, be improved.

According to the present invention there is provided a method, in a first device. The method comprises sending, to a second device, capability information indicating the first device's ability to perform digital post-distortion (DPoD) processing to reduce non-linear distortion in signals received by the first device.

The capability information may comprise one or more metrics indicating an extent of and/or characteristic of non-linear distortion the first device can compensate with DPoD processing. The capability information may comprise an indication of a preference for a distortion level, a distortion shape or function, and/or other characteristic for non-linear distortion the first device can compensate with DPoD processing. The capability information may comprise an indication that the first device can receive and utilize a non-linearity estimation reference signal (NLE-RS) for DPoD processing.

The capability information may comprise an indication that the first device can receive and utilize power amplifier (PA) response information for DPoD processing.

In some embodiments, at least part of the capability information is sent using Radio Resource Control (RRC) signaling.

At least part of the capability information may be specific to a frequency band.

The method may further comprise receiving a request for capability information indicating the first device's ability to perform DPoD processing. The above sending may be in response to said request.

In some embodiments, the method may comprise dynamically signaling, to the second device, an indication of DPoD processing use. The indication of DPoD processing use may identify one of two or more predetermined DPoD configurations.

In some embodiments, the method may further comprise receiving, from the second device or a third device, configuration information indicating that the first device is to apply DPoD processing to reception of one or more signals transmitted to the first device. The configuration information may indicate one or more channels, one or more time intervals, one or more frequency bands, and/or one or more transmission types to which the first device is to apply the DPoD processing. In some embodiments at least part of the configuration information may be received via Radio Resource Control (RRC) signaling. In some embodiments, at least part of the configuration information may be received via dynamic signaling.

The method may further comprise receiving a signal; and performing DPoD processing on the signal.

In some embodiments, the method may further comprise receiving, from the second device, one or more of: an indication that the second device can transmit a non-linearity estimation reference signal (NLE-RS); an indication that the second device can send power amplifier (PA) response information; and power amplifier (PA) response information.

In some embodiments, the method may comprise receiving, from the second device, an indication that the second device can adapt its transmission of signals to the second device based on DPoD capabilities of the first device.

There is further provided a method, in a first device, comprising receiving, from a second device, capability information indicating the second device's ability to perform digital post-distortion (DPoD) processing to reduce non-linear distortion in signals received by the second device.

The method may further comprise adapting one or more transmissions to the second device, based on the capability information.

The capability information may comprise one or more of: one or more metrics indicating an extent of and/or characteristic of non-linear distortion the second device can compensate with DPoD processing; an indication of a preference for a distortion level, a distortion shape or function, and/or other characteristic for non-linear distortion the second device can compensate with DPoD processing; an indication that the second device can receive and utilize a non-linearity estimation reference signal (NLE-RS) for DPoD processing; an indication that the second device can receive and utilize power amplifier (PA) response information for DPoD processing.

In some embodiments at least part of the capability information may be received using Radio Resource Control (RRC) signaling.

At least part of the capability information may be specific to a frequency band.

The method may further comprise sending, to the second device, a request for capability information indicating the second device's ability to perform DPoD processing. The said receiving may be in response to said request.

In some embodiments, the method comprises receiving, from the second device, an indication of DPoD processing use. The method may further comprise adapting one or more transmissions sent to the second device based on said indication of DPoD processing use. The indication of DPoD processing use may identify one of two or more predetermined DPoD configurations.

The method may further comprise sending, to the second device, configuration information indicating that second device is to apply DPoD processing to reception of one or more signals transmitted to the second device. The configuration information may indicate one or more channels, one or more time intervals, one or more frequency bands, and/or one or more transmission types to which the second device is to apply the DPoD processing. In some embodiments, at least part of the configuration information may be sent via Radio Resource Control (RRC) signaling. In some embodiments, at least part of the configuration information may be sent via dynamic signaling.

In some embodiments, the method may further comprise sending, to the second device, one or more of: an indication that the first device can transmit a non-linearity estimation reference signal (NLE-RS); an indication that the first device can send power amplifier (PA) response information; power amplifier (PA) response information; an indication that the first device can adapt its transmission of signals to the second device based on DPoD capabilities of the second device.

In some embodiments, the first device may be a user equipment, UE, and the second device may be a base station. In other embodiments, the first device may be a base station, and the second device may be a user equipment, UE. In other embodiments, the first and second devices may each be user equipments, UEs.

There is further provided an apparatus comprising receiver circuitry, transmitter circuitry, and processing circuitry operatively coupled to the receiver circuitry and transmitter circuitry, wherein the processing circuitry is configured/adapted to use the receiver circuitry and/or transmitter circuitry to carry out a method as described above.

There is further provided a network node comprising the apparatus. The network node may be a base station.

There is further provided a user equipment, UE, comprising the apparatus.

### BRIEF DESCRIPTION OF THE FIGURES

Some of the embodiments contemplated herein will now be described more fully, by way of example only, with reference to the accompanying drawings, in which:

FIG. 1 illustrates Discrete-Fourier-Transform-spread OFDM.

FIG. 2 is a block diagram illustrating components of a receiver circuit and a transmitter circuit, providing a setting for the techniques to be described herein.

FIG. 3 is a process flow diagram illustrating steps carried out by a device, according to some embodiments.

FIG. 4 is a process flow diagram illustrating another example method carried out in a device, according to some embodiments.

FIG. 5 is a process flow diagram illustrating still another example method carried out in a device, according to some embodiments.

FIG. 6 is a process flow diagram illustrating another example method carried out in a device, according to some embodiments.

FIG. 7 is a process flow diagram illustrating another example method carried out in a device according to some embodiments.

FIG. 8 is a process diagram illustrating another example method carried out in a device according to some embodiments.

FIG. 9 is a process diagram illustrating another example method carried out in a device according to some embodiments.

FIG. 10 is a process diagram illustrating another example method carried out in a device.

FIG. 11 is a process diagram illustrating another example method carried out in a device.

FIG. 12 illustrates an example communication system, according to some embodiments.

FIG. 13 shows an example user equipment (UE) in which the techniques described herein may be implemented, in some embodiments.

FIG. 14 shows an example network node which the techniques described herein may be implemented, in some embodiments.

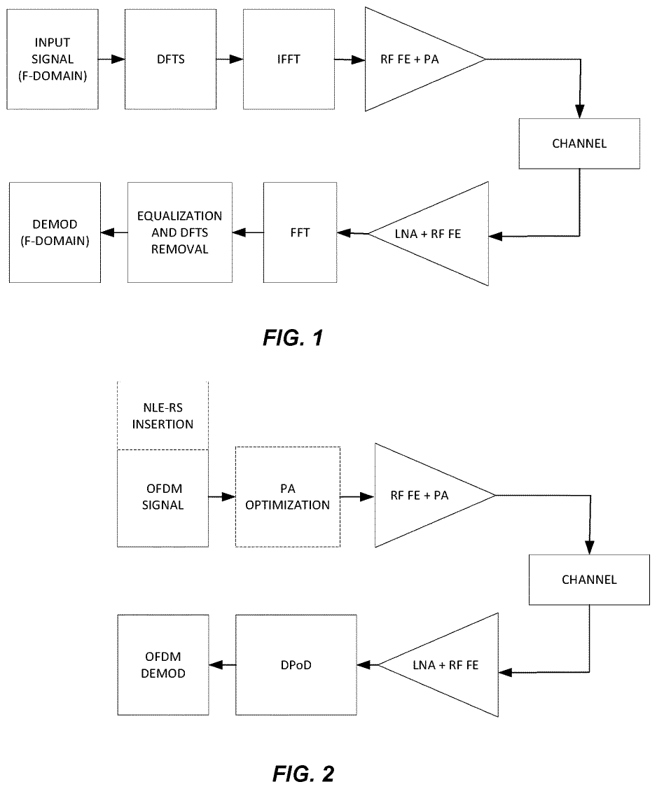

### DETAILED DESCRIPTION

FIG. 2 is a block diagram illustrating components of a receiver circuit and a transmitter circuit, providing a setting for the techniques to be described herein. It will be appreciated that the receiver circuit will be found in a first device, while the transmitter circuit is found in a second device. The first and second devices will include a corresponding transmitter circuit and receiver circuit, respectively. The first and second devices might be a UE and a base station, a base station and a UE, or two UEs, in various embodiments or instances.

The setting for the techniques described herein is that a receiving node in a wireless network (a UE in the DL or a gNB in the UL or a UE in a sidelink) performs DPoD processing on a received signal to remove or reduce the non-linear distortion caused by a non-linear (NL) PA in a transmitting node (a gNB or a UE, respectively). In the example embodiments below, the device performing the DPoD is mostly referred to as UE, nevertheless, similar examples can also be applied to gNB or other types of RX/TX.

The high-level signal flow may be depicted as conventional OFDM transmission, which may comprise cyclic-prefix OFDM, e.g., as commonly used by eNBs in LTE systems, or Discrete-Fourier-Transform-spread OFDM (DFTS-OFDM), also known as single-carrier frequency-division multiple access (SC-FDMA), e.g., as commonly used by UEs in LTE systems. On the receiver (RX) side, a DPoD processing stage is added, following the low-noise amplifier (LNA) and other radio frequency (RF) front end (FE) components. On the transmitter (TX) side, to indicate possible power amplifier (PA) optimization, an optional processing block is depicted that may involve CFR, DPD, TR, or other PA efficiency improvement solutions. Also optionally, a reference signal (RS) for estimating the residual PA non-linearity, referred to herein as a non-linearity estimation reference signal (NLE-RS), may be inserted in the OFDM signal, or prior to/after the OFDM signal. The RS can also be transmitted for a group of OFDM signals separately, e.g., one RS is transmitted before several OFDM signals, e.g., PDSCHs. Note that “RS” in this and similar contexts may alternatively be interpreted as referring to “reference symbols”-thus, one or more reference symbols make up a reference signal. These usages should be understood as interchangeable in the present document.

The DPoD operation in the RX may constitute any one or more of various types of processing, where some non-limiting examples may include:
processing of the complete received signal in the time domain;
spatially separating a component of the received signal and processing it in the time domain;
spatially or frequency-separating a component of the received signal in the frequency domain and processing its representation in the time domain using additional domain conversion;
estimating the distortion leaking into an adjacent channel, including its frequency dependent transfer over the channel, and performing cancelation so that the effect on the adjacent channel signal reception is minimized;
estimating and canceling distortion due to memory effects in the transmitter; and
determining a non-linearity model of the transmitter by analyzing the reference signals (RS).

In some embodiments, the signaling approaches described herein may be tailored to implementation details of the selected DPoD approach but the main ideas are independent of the specific DPoD methods.

The techniques provide signaling mechanisms by which the RX and TX nodes may align their operation and the TX node may provide assistance/support information that is useful for the DPoD processing.

### Capability and Preference Signaling

The TX and RX may exchange capability information regarding DPoD functionality, NLE-RS support, PA response reporting, TX PA optimization and adaptation, etc. They may also exchange preference information, e.g., an indication by the RX at which distortion level it can/would prefer to operate its DPoD.

For downlink (DL) DPoD processing, the UE may provide capability information indicating that it can perform DPoD processing. In one embodiment, this capability is expressed as a functionality only, in others the capability may be quantified in terms of metrics, such as error vector magnitude (EVM), cubic metric, etc., describing the extent or characteristic of the NL distortion that may be compensated for.

In some embodiments, the UE may provide additional preference information, e.g., via the UAI framework or another RRC framework, indicating which distortion level, distortion shape/function, or other characteristic the UE can or would prefer to currently operate its DPoD function.

The UE may provide capability information that it can receive/utilize NLE-RS, and that it can dynamically request NLE-RS.

The UE may provide capability/feature information that it can/desires to request PA response information, where “PA response information” refers to information indicative of or characterizing the transfer function of the PA and/or certain characteristics of its nonlinear response.

For reporting these capabilities, the conventional UE capability reporting framework may be used, or the UE may report it within any other control signaling, e.g., as part of a Radio Resource Control (RRC) configuration procedure using RRC signaling. The capability indication may be frequency band specific.

In some embodiments, the DPoD processing capability may be dynamic and may depend on the UE energy status or other ongoing processing, and may be reported using dynamic methods, e.g., via Medium Access Control Control Element (MAC CE) or via Uplink Control Information (UCI), including indicating one of preconfigured options as being currently in effect. The list of preconfigured options may be provided by the UE in the above capability reporting or RRC signaling, or by the gNB via RRC signaling.

In some embodiments, the UE may provide multiple capability information elements. One capability information element can be a default, or a reference for the other capability information element. Regarding the reporting of these multiple capabilities, the UE may provide a capability information identity to differentiate from other capability information. An example for different capability information can have different pre-distortion calculation, e.g., default or reference may have less computational cost for pre-distortion calculation, while other capability information may have high computational cost and high accuracy for pre-distortion calculation.

For the uplink (UL), the UE may provide capability information that it can transmit NLE-RS, and that it can receive dynamic requests for NLE-RS.

The UE may provide capability/feature information that it can provide PA response information, and that it can provide this information periodically and/or on aperiodically or on demand.

The UE may provide multiple PA response information from multiple capability/feature information. It may provide this information compressed together periodically, or aperiodically to avoid increase of signaling.

The UE may provide capability information indicating that it is able to adapt its transmission of UL signals when the gNB is equipped with DpoD. For example, the UE may be able to transmit with higher MCS than the case where the gNB does not apply DpoD.

For reporting these capabilities, the conventional capability reporting framework may be used, or the UE may report it using RRC signaling.

### Scheduling DL/UL

In the downlink, in some embodiments, the UE may receive a configuration from the gNB or another UE that it should apply DPoD in reception of one or more scheduled DL signals, e.g., PDSCHs, or during certain scheduling time intervals, e.g., specific slots or symbols, or for certain TX modes or formats (e.g., single-layer DFTS-OFDM transmission, or operation in FR2 or sub-THz frequency range.

In one example, the configuration is received from higher layer signaling, e.g., RRC signaling. And as such the UE can expect that one or more scheduled DL signals/channels should be received with DPoD. For example, the UE may be configured to apply DPoD to all the scheduled DL PDSCH using a DCI associated with a C-RNTI, but the UE does not have to apply DPoD e.g., to PDSCH scheduling with a paging DCI.

In another example, the configuration is received using L1/L2 based signaling such as DCI or MAC-CE. For example, a MAC-CE can be used to indicate that the UE should apply DPoD to what type of received DL signals/channels. Alternatively, a DCI-based mechanism, e.g., as part of a scheduling DCI or an independent DCI, or a group common DCI can be used to indicate that the UE should apply DPoD for reception of a scheduled DL signal/channel.

For the uplink, in one example, the UE receives a configuration or indication that it can operate in the NL part of PA in the UL, i.e., that it can operate its PA in a non-linear mode, which is a mode with increased non-linearity (but typically more efficiency) compared to a default mode. The UE may additionally receive an indication that the gNB or another UE or other receivers apply DPoD and as such the UE is allowed to operate in the NL domain of PA when scheduled in the UL.

In another example, the UE receives an indication that the receiver applies DPoD, and as such the UE can consider that when reporting, e.g., channel qualities, or transmitting SRS, or reporting based on the received NLE-RS. As such then when the UE receives an scheduling for UL, e.g., SR, RACH, PUCCH, PUSCH, then it can operate in the NL domain and allow the receiver, e.g., gNB or another UE to take care of the distortions. In another example, the UE may receive an indication that it should transmit NLE-RS along an UL signal/channel.

In all the examples above, the configuration or indication can be received by higher layer signaling. For example, RRC signaling can be used to let the UE know that e.g., the gNB applies DPoD in reception, or that the actions the UE should take when scheduled with one or more specific UL channels. E.g., specific actions may apply to PUSCH and PUCCH but not to RACH.

In other embodiments, the indication can be a L1/L2 signaling such as MAC-CE or DCI. For example, the UE may receive a DCI scheduling UL and additionally indicate if the UE should transmit NLE-RS, or other commands.

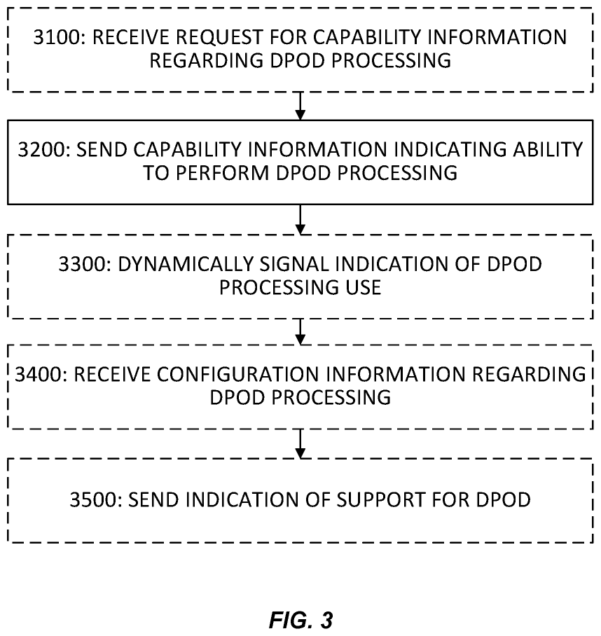

FIG. 3 is a process flow diagram illustrating one example of a method according to several of the techniques described above. It should be understood that the illustrated method is intended to generalize and to encompass many of the specific examples provided above. Thus, where the terminology used below to describe FIG. 3 differs from the terminology above, terms used below should be understood to at least encompass similar or clearly related/analogous terms used above.

The method shown in FIG. 3 is implemented in a first device, which may be, in various instances or embodiments, a UE or base station. The method comprises, as shown at block 3200, the step of sending, to a second device, capability information indicating the first device's ability to perform digital post-distortion (DPoD) processing to reduce non-linear distortion in signals received by the first device. The second device may also be, in various instances or embodiments, a UE or base station. Accordingly, the capability information may relate to DPoD processing for DL, UL, or sidelink signals, in various instances and embodiments.

In some embodiments or instances, the capability information comprises one or more metrics indicating an extent of and/or characteristic of non-linear distortion the first device can compensate with DPoD processing. In some embodiments or instances, the capability information comprises an indication of a preference for a distortion level, a distortion shape or function, and/or other characteristic for non-linear distortion the first device can compensate with DPoD processing.

In some embodiments or instances, the capability information comprises an indication that the first device can receive and utilize a non-linearity estimation reference signal (NLE-RS) for DPoD processing. In some embodiments or instances, the capability information comprises an indication that the first device can receive and utilize power amplifier (PA) response information for DPoD processing.

In some embodiments or instances, at least part of the capability information is sent using Radio Resource Control (RRC) signaling. In some embodiments or instances, at least part of the capability information is specific to a frequency band.

In some embodiments or instances, the method comprises receiving a request for capability information indicating the first device's ability to perform DPoD processing. This is shown in FIG. 3 at block 3100. In these embodiments, the sending of the capability information is in response to the request.

In some embodiments or instances, the method comprises dynamically signaling, to the second device, an indication of DPoD processing use. This may be separate from the sending of capability information, e.g., as shown at block 3300 in FIG. 3. In some of these embodiments or instances, this indication of DPoD processing use identifies one of two or more predetermined DPoD configurations.

In some embodiments or instances, the method further comprises receiving, from the second device or a third device, configuration information indicating that the first device is to apply DPoD processing to reception of one or more signals transmitted to the first device. This is shown at block 3400. The first device may then apply DPoD processing in accordance with this configuration information. In some embodiments or instances, the configuration information indicates one or more channels, one or more time intervals, one or more frequency bands, and/or one or more transmission types to which the first device is to apply the DPoD processing. In some embodiments or instances, at least part of the configuration information is received via Radio Resource Control (RRC) signaling. In some embodiments or instances, at least part of the configuration information is received via dynamic signaling.

In some embodiments or instances, the first device may be capable of supporting DPoD processing at the second device and/or adapting transmissions based on DPoD capabilities of the second device, as well as performing its own DPoD processing on received signals. Thus, in some embodiments or instances of the method shown in FIG. 3, the method may further comprise sending, to the second device, an indication that the first device can transmit a non-linearity estimation reference signal (NLE-RS). This is shown generically at block 3500 of FIG. 3, which refers to the sending of an indication of DPoD support. As another example of this support, the method may comprise sending, to the second device, an indication that the first device can send power amplifier (PA) response information, or sending, to the second device, power amplifier (PA) response information for the first device. As still another example, the first device may send, to the second device, an indication that the first device can adapt its transmission of signals to the second device based on DPoD capabilities of the second device.

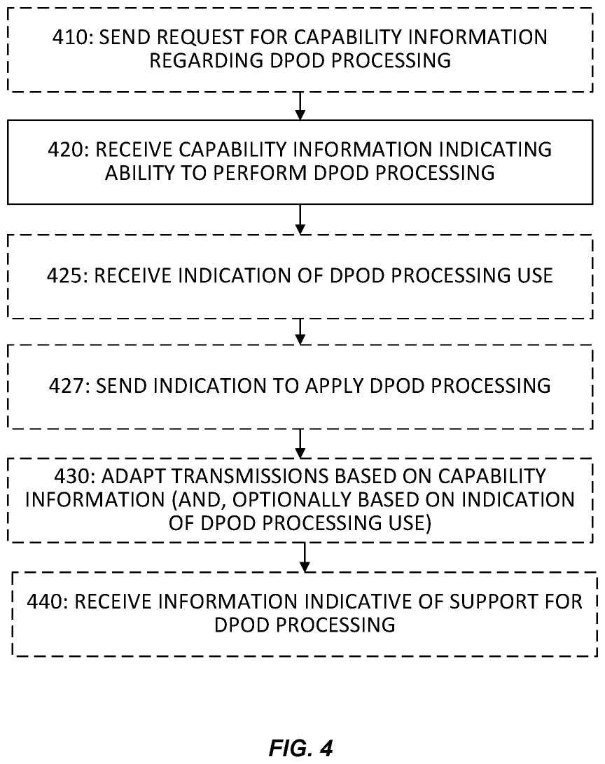

FIG. 4 is a process flow diagram illustrating another example of a method according to several of the techniques described above. Again, it should be understood that the illustrated method is intended to generalize and to encompass many of the specific examples provided above. Thus, where the terminology used below to describe FIG. 4 differs from the terminology used above to describe specific examples, terms used below should be understood to at least encompass similar or clearly related/analogous terms used above.

The method shown in FIG. 4 is implemented in a first device, which may be, in various instances or embodiments, a UE or base station. The techniques shown in FIG. 4 may be used alone, or along with one or more of the techniques corresponding to FIG. 3, such that they are performed by the same device. Thus, the “first device” referred to here may be the same as the “first device” carrying out a method according to FIG. 3, or it may be the same as the “second device” referred to above, or it may be another device.

The method comprises, as shown at block 420, the step of receiving, from a second device, capability information indicating the second device's ability to perform digital post-distortion (DPoD) processing to reduce non-linear distortion in signals received by the second device. The method may further comprise, as shown at block 430, adapting one or more transmissions to the second device, where this adapting is based on the capability information. As mentioned above, this adapting may comprise allowing for more non-linearities in transmissions to the second device, e.g., by operating the PA in a more non-linear mode. This may include using a higher modulation and coding scheme (MCS) than would be available or appropriate if no DPoD processing was available at the receiving end.

In some embodiments or instances, the capability information comprises one or more metrics indicating an extent of and/or characteristic of non-linear distortion the second device can compensate with DPoD processing. In some embodiments or instances, the capability information comprises an indication of a preference for a distortion level, a distortion shape or function, and/or other characteristic for non-linear distortion the second device can compensate with DPoD processing.

In some embodiments or instances, the capability information comprises an indication that the second device can receive and utilize a non-linearity estimation reference signal (NLE-RS) for DPoD processing. In such cases, the adapting of transmissions may comprise including NLE-RS in transmissions to the second device, in response.

In some embodiments or instances, the capability information comprises an indication that the second device can receive and utilize power amplifier (PA) response information for DPoD processing. The first device may send PA response information to the second device in response, in some of these embodiments or instances.

In some embodiments or instances, at least part of the capability information is received using Radio Resource Control (RRC) signaling. In some embodiments or instances, at least part of the capability information is specific to a frequency band.

In some embodiments or instances, the method comprises sending, to the second device, a request for capability information indicating the second device's ability to perform DPoD processing. This is shown at block 410 in FIG. 4. In such embodiments or instances, the receiving of capability information as shown at block 420 may be in response to this request.

In some embodiments or instances, the method may comprise receiving, from the second device, an indication of DPoD processing use. This is shown at block 425. In such embodiments or instances, the adapting of one or more transmissions sent to the second device, as shown at 430, may be based on said indication of DPoD processing use. In some embodiments or instances, this indication of DPoD processing use identifies one of two or more predetermined DPoD configurations.

In some embodiments or instances, the method may further comprise sending, to the second device, configuration information indicating that second device is to apply DPoD processing to reception of one or more signals transmitted to the second device. This is shown in FIG. 4 at block 427. In some embodiments or instances, this configuration information indicates one or more channels, one or more time intervals, one or more frequency bands, and/or one or more transmission types to which the second device is to apply the DPoD processing. At least part of the configuration information is received via Radio Resource Control (RRC) signaling, in some embodiments or instances. Likewise, at least part of the configuration information may be sent via dynamic signaling, in some embodiments or instances.

In some embodiments or instances, the method may comprise receiving, from the second device, an indication that the second device can transmit a non-linearity estimation reference signal (NLE-RS). This is shown at block 440, which generically describes this as receiving information indicative of support for DPoD processing. Other examples of receiving such information are receiving an indication that the second device can send power amplifier (PA) response information, receiving, power amplifier (PA) response information, and receiving, from the second device, an indication that the second device can adapt its transmission of signals to the first device based on DPoD capabilities of the first device. The support information referred to at block 440 may include one or several of these types of indications/information.

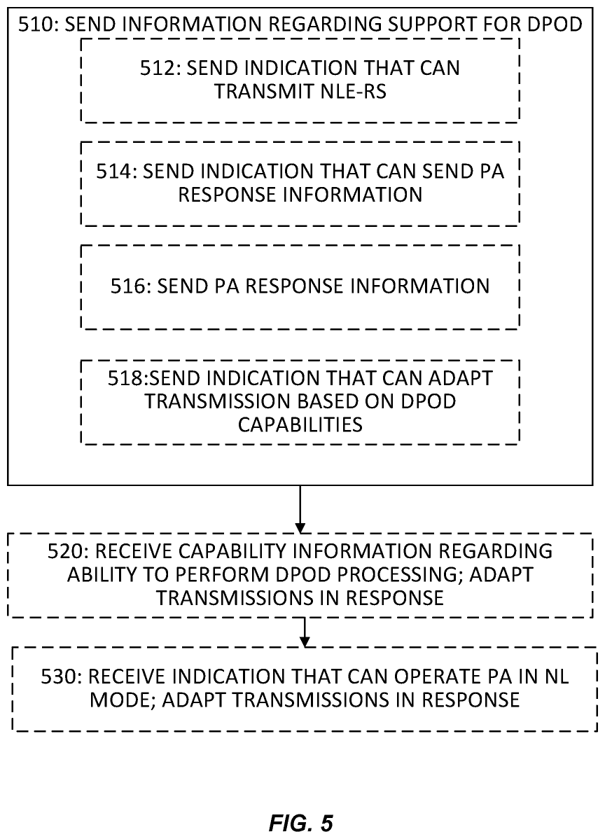

FIG. 5 is a process flow diagram illustrating another method, consistent with several examples detailed above. This method can be used in conjunction with or to complement one or more of the variations of methods corresponding to FIGS. 3 and 4.

As shown at block 512, the method comprises sending, to a second device, an indication that the first device can transmit a non-linearity estimation reference signal (NLE-RS). Note that this is an example of the “support” for DPoD discussed above—FIG. 5 illustrates this indication as one possible example of a “sending information regarding support for DPoD processing,” in block 510.

In some instances or embodiments, the method may instead or in addition comprise sending, to the second device, an indication that the first device can send power amplifier (PA) response information. This is shown at block 514. Similarly, in some instances or embodiments, the method may comprise sending, to the second device, power amplifier (PA) response information, and/or sending, to the second device, an indication that the first device can adapt its transmission of signals to the second device based on DPoD capabilities of the second device. These are shown at blocks 516 and 518.

In some embodiments the method may comprise, as shown at block 520, receiving, from the second device, capability information indicating the second device's ability to perform digital post-distortion (DPoD) processing to reduce non-linear distortion in signals received by the second device and adapting transmission of signals to the second device based on the received capability information.

In some embodiments or instances, the method may comprise receiving, from the second device, an indication that the first device can operate the first device's power amplifier (PA) in a non-linear mode, and adapting transmission of signals to the second device based on the received indication. This is shown at block 530.

As with the other examples provided above, the first device may be a UE and the second device a base station, or the first device may be a base station and the second device a UE, or both devices may be UEs, in various embodiments or instances.

In view of the detailed examples and explanation provided above, it will be appreciated that the list below lists core aspects of some embodiments of the presently disclosed techniques, on the UE side, for the downlink and uplink, respectively. These aspects should be interpreted as being consistent with various examples given above.

### UE Actions in the DL

1. A method in a UE for controlling DPoD operation, the method comprising:
   signaling DPoD capability info or preference info to a gNB,
   receiving from the gNB one or more of: DPoD configuration info and DPoD activation commands,
   (performing DPoD based on the configuration or commands).
2. + the capability info comprises one or more of support of compander functionality compander metric, compander function support, compander function parameter support.
   a. + multiple capabilities may be reported.
3. + the configuration info comprises one or more of compander function,
   compander function parameter values, on which signals, in which time instants, or
   on which transmission formats to apply DPoD, or on which not to apply it.
4. + the preference info comprises one or more of preferred input signal distortion level, function, value, preferred compander function and function parameter values,
5. + the activation commands comprise one or more of a trigger for applying DPoD once, a trigger to activate periodic or constant DPoD operation, or to deactivate such operation.

### UE Actions in the UL

6. A method in a UE for assisting DPoD operation in a gNB, the method comprising one or more of:
   signaling DPoD assistance capability info to the gNB,
   receiving from the gNB assistance request or assistance configuration,
   signaling to the gNB DPoD assistance information,
   receiving from the gNB DPoD usage indication and DPoD activation support,
   signaling to the gNB activation of DPoD.
7. + the assistance capability info comprises one or more of DPoD assistance RS transmission, transmitted signal non-linearity characteristic, transmitted signal non-linearity sensitivity,
8. + the request info comprises one or more of request to provide assistance info once, or periodically,
9. + the configuration info comprises one or more of type of assistance info, report contents, etc.
10. + signaling the activation comprises indicating to the gNB during which channels, symbols, slots, etc. the gNB should apply DPoD:

Note that gNB (base station) signaling steps for DL and UE are direct counterparts to the UE embodiments summarized immediately above.

As described above, as part of activating and utilizing the DPoD feature, the TX and RX may exchange capability information regarding DPoD functionality, NLE-RS support, PA response reporting, TX PA optimization and adaptation, etc. They may also exchange preference information, e.g., an indication by the RX at which distortion level it can/would prefer to operate its DPoD. They may also exchange activation information, e.g., indications or commands that the DPoD functionality is ongoing or should be activated, where the activation may apply to a subset of transmissions in time, specific channels, specific transmission modes/formats, etc.

The techniques described herein include signaling mechanisms by which the RX and TX nodes may align their operations and the TX node may provide special RS that is useful for the DPoD processing.

### NLE-RS Transmission and Control

A NLE-RS may be transmitted to aid the RX in estimating the NL characteristic after the PA and/or the channel and other processing stages, e.g. equalization. The NLE-RS may be embedded in the transmitted signal and it will be subjected to NL effects similar to the rest of the signal. For example, an NLE-RS may be inserted in reserved symbols or parts of symbols (sample subsets). The NLE-RS may consist of sample groups with different predetermined magnitudes, so that the NL mapping from TX input to DPoD output may be characterized at the RX. Alternatively, a corresponding RS may be inserted in the frequency domain (F-domain) and mapped to distinct time (T-domain) samples after the IFFT of the OFDM modulation processing.

Such an RS can also be transmitted prior to or after a signal, or a group of signals. In one embodiment, the NLE-RS may be transmitted separately from data/control signals but with PA and other transmitter settings configured to match the settings during the transmissions of those signals.

The TX and RX may exchange signaling to control NLE-RS transmission: to configure one or more parameters of the RS, to request, and to indicate the transmission. The RS activation may be periodic or aperiodic.

In one embodiment, the NLE-RS characteristics may change per transmission occasion and the information about the characteristics is provided to the RX. In a DL example, in a first occasion (e.g., a first slot), a portion of the data (e.g., PDSCH) is amplified to a distorted level, and the NLE-RS in that occasion is transmitted with a power and/or structure such that the DPoD stage can estimate the relevant distortion. Then in the next transmission occasion (e.g., the next slot) the PA may be operating predominantly in the linear area and the NLE-RS output power may be adapted so that it is suitably scaled for estimating the relevant distortion region for this occasion. The UE may be dynamically informed, e.g., in a non-distorted PDCCH downlink control information (DCI), about the NLE-RS characteristics (in the example above the absolute or delta dB level variations) per transmission occasion.

With regards to downlink (DL) DPoD, the UE may provide capability information that it can receive/utilize NLE-RS, including supported formats and parameter settings, and that it can dynamically request NLE-RS. For reporting these capabilities, the conventional UE capability reporting framework may be used, or the UE may report it within any other control signaling, e.g., as part of RRC configuration procedure using RRC signaling. The capability indication may be frequency-band specific.

The UE may provide preference information on which RS format or configuration it currently prefers. The preference may be provided via the UAI framework or other RRC or MAC CE signaling.

The UE may receive from the gNB a NLE-RS configuration that the gNB will transmit, which may specify the RS type or mode, temporal pattern (period, or aperiodic), T/F resources, code/sequence seeds or indices, etc. This may be provided via dedicated RRC signaling.

The UE may transmit to the gNB a preference or a request for NLE-RS transmission. The preference may contain an indication that the RS should be transmitted, and optionally the preferred configuration, e.g., transmission rate or magnitude resolution. The preference may be provided via the UE assistance information (UAI) framework or in-band such as via control information embedded in the feedback provided per transmission. The request may convey an indication that a RS transmission (periodic or aperiodic) is desired. It may be signaled via a UCI or MAC CE.

The UE may receive an indication that the configured or requested NLE-RS is being transmitted, e.g., via DCI or MAC CE.

Additionally, or instead, the UE may receive the actual RS transmission embedded in the transmitted DL signal, according to the received configuration. The UE may then use the RS to estimate the NL characteristics of the received signal and configure the DPoD algorithm to apply appropriate compensation.

The UE may receive a configuration that indicates that a NLE-RS will be transmitted prior to/after the scheduled DL signal, or as independent RS.

The UE may receive a configuration/indication/scheduling to report one or more parameter based on the received NLE-RS, e.g., the level of expected distortion, preferred coefficient associated to a PA optimization technique such as DPD in the TX side, or the employed DPoD mechanism at the YE, a DPoD associated CQI, RI, L1-SINR, PMI, etc.

With regards to DPoD on the uplink, the UE may provide capability information that it can transmit NLE-RS, and/or that it can receive dynamic requests for NLE-RS.

The UE may receive, from the gNB, a NLE-RS configuration that the UE shall use to transmit to the gNB, which may specify the RS type or mode, temporal pattern (period, or aperiodic), time-frequency (T/F) resources, code/sequence seeds or indices, etc. This may be provided via dedicated RRC signaling.

The UE may also receive from the gNB a multiple NLE-RS configuration which have different RS type or mode, temporal pattern (period, or aperiodic), T/F resources, code/sequence seeds or indices, etc. This can be compressed together via dedicated RRC signaling.

The UE may receive an order to transmit the configured NLE-RS, the order signaled via, e.g., DCI or MAC CE. For the case of multiple NLE-RS, the UE may receive a compressed order to transmit the configured NLE-RS.

The UE may be requested e.g., as part of scheduling an UL signal such as PUCCH/PUSCH or transmit an NLE-RS along with the UL, or simply to transmit a NLE-RS. The UE may additionally receive an indication of what type of NLE-RS to transmit.

The UE may receive a configuration in response to transmission of an NLE-RS, indicating, e.g., the level of expected distortion, the coefficients to be used e.g., in a PA optimization technique such as DPD, or the ones associated with a DPoD mechanism, a DPoD associated MCS, transmit power, precoder, etc.

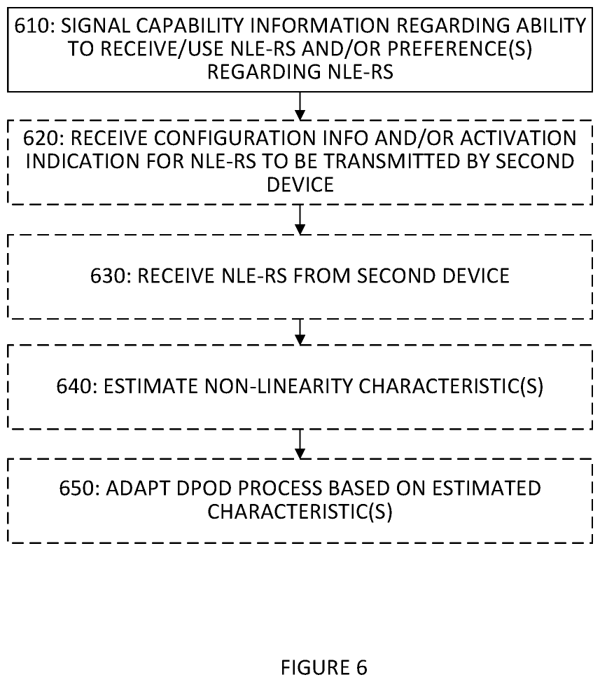

FIG. 6 is a process flow diagram illustrating one example of a method according to several of the techniques described above. It should be understood that the illustrated method is intended to generalize and to encompass many of the specific examples provided above.

Thus, where the terminology used below to describe FIG. 6 differs from the terminology above, terms used below should be understood to at least encompass similar or clearly related/analogous terms used above.

The method shown in FIG. 6 is implemented in a first device, which may be, in various instances or embodiments, a UE or base station. The method comprises, as shown at blocks 610 and 620: signaling, to a second device, one or more of (a) capability information regarding the ability of the first device to receive and/or use a non-linearity estimation reference signal (NLE-RS) and (b) one or more preferences regarding reception and/or use of NLE-RS; and/or receiving, from the second device, configuration information for NLE-RS to be transmitted by the second device and/or an activation indication for NLE-RS transmission by the second device.

In some embodiments or instances, the method further comprises receiving NLE-RS from the second device. This is shown at block 630. In some embodiments or instances, the NLE-RS is multiplexed by the second device in the transmitted signal in the frequency domain after compression. In other embodiments or instances, the NLE-RS is multiplexed by the second device in the transmitted signal in the frequency domain before compression. In still other embodiments or instances, the NLE-RS is multiplexed by the second device in the transmitted signal in the time domain after compression.

In some embodiments or instances, the method further comprises, as shown at blocks 640 and 650, estimating a non-linearity characteristic of a received signal, using the NLE-RS, and adapting digital post-distortion (DoPD) processing of the received signal based on the estimated characteristic.

In various embodiments or instances, the capability information comprises any one or more of: an indication of support for NLE-RS functionality; an indication of one or more supported NLE-RS formats; and an indication of a supported range for an NLE-RS parameter.

In various embodiments or instances, the configuration information comprises any one or more of: an indication of an NLE-RS format; an indication of transmission resources used for NLE-RS transmission; an indication of one or more parameters for NLE-RS transmission; an indication of one or more time intervals or channels or transmission formats to apply the NLE-RS to; and an indication of one or more time intervals or channels or transmission formats to which the NLE-RS should not be applied.

In various embodiments or instances, the one or more preferences may comprise any one or more of: a preferred NLE-RS format; preferred NLE-RS transmission resources; a preferred NLE-RS parameters; a preferred time interval or channel or transmission formats to apply the NLE-RS to; and a preferred time interval or channel or transmission formats to which the NLE-RS should not be applied.

In some embodiments or instances, the activation indication may indicate that a one-time NLE-RS is being or will be transmitted. In others, the activation indication indicates that a periodic NLE-RS is being or will be transmitted.

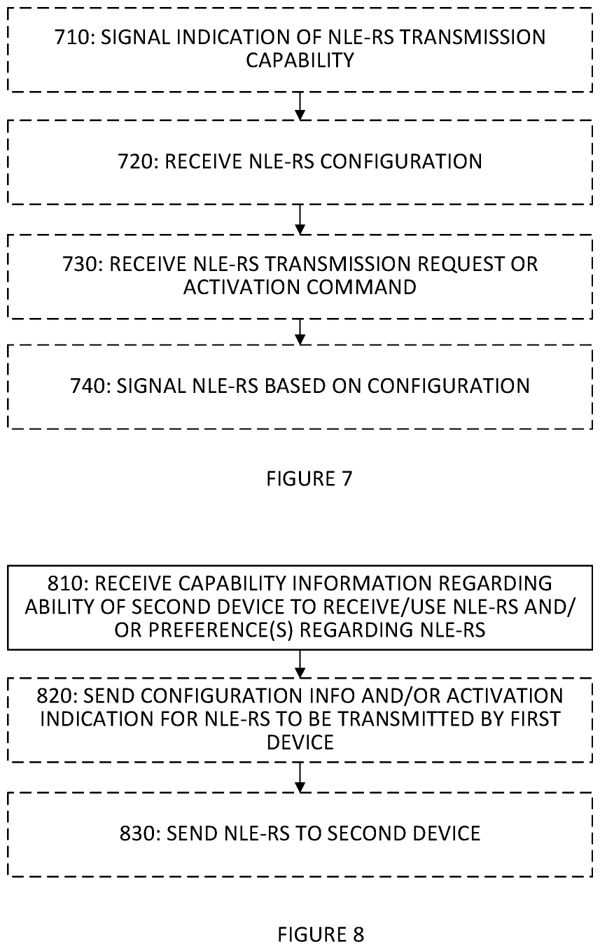

FIG. 7 illustrates another example method as might be performed by a first device. Again, the illustrated method is intended to generalize and to encompass many of the specific examples provided above. Thus, where the terminology used below to describe FIG. 7 differs from the terminology above, terms used below should be understood to at least encompass similar or clearly related/analogous terms used above.

The method shown in FIG. 7 is implemented in a first device, which may be, in various instances or embodiments, a UE or base station. The method comprises, as shown at block 710, signaling an indication of non-linearity estimation reference signal (NLE-RS) transmission capability of the first device to a second device. Alternatively or in addition, as shown at block 720, the method may comprise receiving, from the second device, a NLE-RS configuration for NLE-RS to be transmitted by the first device. Alternatively or in addition, as shown at block 730, the method may comprise receiving, from the second device, an NLE-RS transmission request or activation command. In some embodiments or instances, the method may still further comprise signaling, to the second device, NLE-RS based on the configuration.

In various embodiments or instances, the indication of NLE-RS transmission capability of the first device comprises one or more of: an indication of support for NLE-RS functionality; an indication of one or more supported NLE-RS formats; and an indication of a supported range for an NLE-RS parameter.

In various embodiments or instances, the NLE-RS configuration received from the second device may comprise one or more of: an indication of an NLE-RS format; an indication of transmission resources used for NLE-RS transmission; an indication of one or more parameters for NLE-RS transmission; an indication of one or more time intervals or channels or transmission formats to apply the NLE-RS to; and an indication of one or more time intervals or channels or transmission formats to which the NLE-RS should not be applied.

In some embodiments or instances, the activation indication indicates that a one-time NLE-RS should be transmitted by the first device. In other embodiments or instances, the activation indication indicates that a periodic NLE-RS should be transmitted by the first device.

A device may be capable of both transmitting NLE-RS and receiving NLE-RS for performing DPoD processing. In such cases, the method illustrated in FIG. 7 might be implemented in a device that also implements a method according to FIG. 6. Alternatively or additionally, the method shown in FIG. 7 might be implemented in a device at the other end of the signaling shown in FIG. 6, such that the method of FIG. 7 at least partly complements that of FIG. 6.

FIG. 8 illustrates a method that directly complements that of FIG. 6. Again, this method might be implemented along with the method of FIG. 6, in a device that can both receive and transmit NLE-RS, or it might be implemented in a device that plays the role of the “second device” in the description above. In this case, the “first device” and the “second device” described below are reversed, compared to the description of FIG. 6. Again, the illustrated method is intended to generalize and to encompass many of the specific examples provided above. Thus, where the terminology used below to describe FIG. 8 differs from the terminology above, terms used below should be understood to at least encompass similar or clearly related/analogous terms used above.

As shown at block 810, the method of FIG. 8 comprises the step of receiving, from a second device, one or more of (a) capability information regarding the ability of the second device to receive and/or use a non-linearity estimation reference signal (NLE-RS) and (b) one or more preferences of the second device regarding reception and/or use by the second device of NLE-RS. Alternatively or additionally, the method comprises sending, to the second device, configuration information for NLE-RS to be transmitted by the first device and/or an activation indication for NLE-RS transmission by the first device. As shown at block 830, the method may further comprise sending NLE-RS to the second device in a transmitted signal.

In some embodiments or instances, the method comprises multiplexing the NLE-RS in the transmitted signal in the frequency domain after compression. In other instances or embodiments, the method comprises multiplexing the NLE-RS in the transmitted signal in the frequency domain before compression. In still other embodiments or instances, the method comprises multiplexing the NLE-RS in the transmitted signal in the time domain after compression.

In various embodiments or instances, the capability information comprises any one or more of: an indication of support for NLE-RS functionality; an indication of one or more supported NLE-RS formats; and an indication of a supported range for an NLE-RS parameter.

In various embodiments or instances, the configuration information comprises any one or more of: an indication of an NLE-RS format; an indication of transmission resources used for NLE-RS transmission; an indication of one or more parameters for NLE-RS transmission; an indication of one or more time intervals or channels or transmission formats to apply the NLE-RS to; and an indication of one or more time intervals or channels or transmission formats to which the NLE-RS should not be applied.

In various embodiments or instances, the one or more preferences may comprise any one or more of: a preferred NLE-RS format; preferred NLE-RS transmission resources; a preferred NLE-RS parameters; a preferred time interval or channel or transmission formats to apply the NLE-RS to; and a preferred time interval or channel or transmission formats to which the NLE-RS should not be applied.

In some embodiments or instances, the activation indication may indicate that a one-time NLE-RS is being or will be transmitted. In others, the activation indication indicates that a periodic NLE-RS is being or will be transmitted.

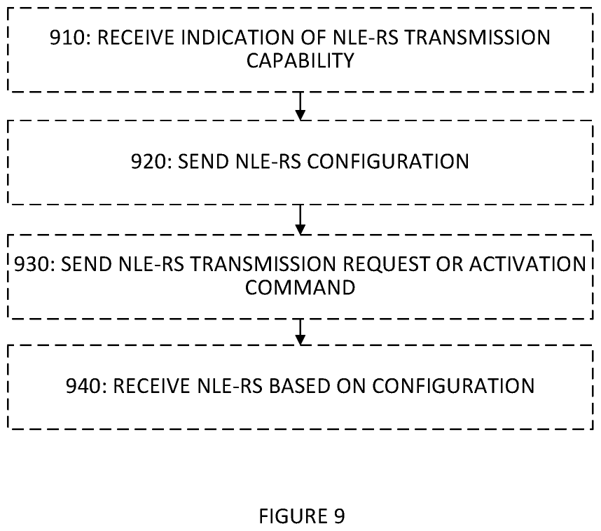

FIG. 9 illustrates another example method as might be performed by a first device. Again, the illustrated method is intended to generalize and to encompass many of the specific examples provided above. Thus, where the terminology used below to describe FIG. 9 differs from the terminology above, terms used below should be understood to at least encompass similar or clearly related/analogous terms used above.

FIG. 9 illustrates a method that directly complements that of FIG. 7. Again, this method might be implemented along with the method of FIG. 7, in a device that can both receive and transmit NLE-RS, or it might be implemented in a device that plays the role of the “second device” in the description of FIG. 7 above. In this case, the “first device” and the “second device” described below are reversed, compared to the description of FIG. 5. Likewise, the method of FIG. 9 might be implemented in a device along with all or part of the method described in FIG. 8.

As shown at block 910, the method comprises the step of receiving, from the second device, an indication of NLE-RS transmission capability of the second device. Alternatively or additionally, as shown at block 920, the method comprises sending, to the second device, a NLE-RS configuration for NLE-RS to be transmitted by the second device. Alternatively or additionally, as shown at block 930, the method comprises sending, to the second device, an NLE-RS transmission request or activation command for NLE-RS to be transmitted by the second device In some embodiments or instances, the method may further comprise, as shown at block 940, receiving NLE-RS from the second device, based on the configuration.

In various embodiments or instances, the indication of NLE-RS transmission capability of the first device comprises one or more of: an indication of support for NLE-RS functionality; an indication of one or more supported NLE-RS formats; and an indication of a supported range for an NLE-RS parameter.

In various embodiments or instances, the NLE-RS configuration received from the second device may comprise one or more of: an indication of an NLE-RS format; an indication of transmission resources used for NLE-RS transmission; an indication of one or more parameters for NLE-RS transmission; an indication of one or more time intervals or channels or transmission formats to apply the NLE-RS to; and an indication of one or more time intervals or channels or transmission formats to which the NLE-RS should not be applied.

In some embodiments or instances, the activation indication indicates that a one-time NLE-RS should be transmitted by the first device.

In any of the methods shown in FIGS. 7-9 and described above, the first device may be a UE and the second device a base station, or the first device may be a base station and the second device a UE, or both devices may be UEs, in various embodiments or instances.

In view of the detailed examples and explanation provided above, it will be appreciated that the list below lists core aspects of some embodiments of the presently disclosed techniques, on the UE side, for the downlink and uplink, respectively. These aspects should be interpreted as being consistent with various examples given above.

### UE Actions in the DL

1. A method in a UE for using NLE-RS for DPoD operation, the method comprising signaling to the gNB DPoD capability info, RS reception capability, and/or RS preference info to a gNB,
   receiving from the gNB one or more of: RS configuration info and RS activation indications, and
   receiving from the gNB the transmitted RS.
   (using the RS based on the configuration or commands for performing DPoD).
2. + the RS capability info comprises one or more of support of RS functionality, specific RS formats, RS parameter ranges, . . . :
3. + the RS configuration info comprises one or more of RS format, RS transmission resources and parameters (T/F/code, scaling), in which time instants, together with which transmitted signals, transmission formats to transmit the RS, or in which not to apply it.
4. + the preference info comprises one or more of preferred RS format, RS transmission resources and parameters (e.g. T/F, scaling), in which time instants, together with which transmitted signals, transmission formats to transmit the RS, or in which not to apply it.,
5. + the activation info comprises one or more of an indication that a one-time or periodic RS is transmitted.
6. + the RS is multiplexed in the transmitted signal in the F-domain after compression, in the F-domain before compression, or in the T-domain after compression.

### UE Actions in the UL

11. A method in a UE for providing NLE-RS for DPoD operation in a gNB, the method comprising one or more of:
   signaling RS transmission capability info to the gNB,
   receiving from the gNB a RS configuration,
   receiving from the gNB a RS transmission request/activation, and
   signaling to the gNB the RS based on the configuration.
12. + the RS transmission capability info comprises one or more of RS functionality, specific RS formats, RS parameter ranges, . . . :
13. + the configuration info comprises one or more of one or more of RS format, RS transmission resources and parameters (T/F/code, scaling), in which time instants, together with which transmitted signals, transmission formats to transmit the RS, or in which not to apply it.
14. + the request/activation comprises one or more of an indication that a one-time or periodic RS should be transmitted.

Note that gNB (base station) signaling steps for DL and UE are direct counterparts to the UE embodiments summarized immediately above.

### PA NL Response Reporting

The TX may have the ability to assess and characterize the non-linearity (NL) properties of the signal at the PA output, which may be used by the RX to appropriately configure the DPoD algorithm. The TX and RX may exchange signaling to control the PA NL response reporting or reporting of other PA or TX status that affects the need for DPoD processing at the RX, e.g., PA mode info (e.g., DPD on/off), PA NL category (DPD function or class applied), NL sensitivity metric (a current output PAPR metric), etc.

With respect to DPoD processing of the downlink signal, the UE may provide capability information that it can receive PA response info, including supported report formats and parameter settings, and that it can dynamically request reports. For reporting these capabilities, the conventional UE capability reporting framework may be used, or the UE may report it within any other control signaling, e.g., as part of RRC configuration procedure using RRC signaling. The capability indication may be frequency-band specific.

The UE may provide preference information on which response report format or configuration it currently prefers. The preference may be provided via the UAI framework or other RRC or MAC CE signaling.

The UE may receive, from the gNB, a configuration for the non-linearity (NL) response report that the gNB will transmit. Note that “response” as used here refers to the transmitter response, or transfer function. An NL response report is thus a report that characterizes the non-linearity of the output of the PA/transmitter and/or the non-linearity of the transfer function of the transmitter/PA circuit. The configuration may specify the report format, NL characterization type (if multiple types supported), reporting pattern, etc. This may be provided via dedicated RRC signaling.

The UE may transmit to the gNB a preference or a request for a NL response report transmission. The preference may contain an indication that the report should be transmitted, and optionally the preferred configuration, e.g., transmission rate or magnitude resolution. The preference may be provided via the UAI framework. The request may convey an indication that a report transmission (periodic or aperiodic) is desired. It may be signaled via uplink control information (UCI) or a Medium Access Control Control Element (MAC CE), for example.

The request for a NL response report from UE to gNB may be for multiple NL response reports, for several time instances, e.g., one request from UE but multiple NL response report from gNB. This may be important for some DPoD algorithm that requires multiple NL response report for better accuracy.

The UE may receive an indication that the configured or requested NL response report is being transmitted, e.g., via downlink control information (DCI) or MAC CE.

Additionally, or instead, the UE may receive the actual NL report transmission, according to the received configuration. The UE may then use the report to extract the NL characteristics of the transmitted signal and configure the DPoD algorithm to apply appropriate compensation.

With regards to DPoD processing of uplink signals, the UE may provide capability information that it can transmit NL response info, and that it can receive dynamic requests for such info.

The UE may receive from the gNB a NL response report configuration that it shall use to transmit to the gNB. It may specify the report format, NL characterization type (if multiple types supported), reporting pattern, etc. This may be provided via dedicated RRC signaling.

The UE may receive an order to transmit the configured NL response report(s), the order signaled via DCI or MAC CE, for example.

### DPoD Adaptation Based on PA Status

In one group of embodiments, the TX may signal to the RX whether, and to what extent to apply DPoD based on the current PA optimization mode. For example, if efficient DPD is used, the need for DPoD may be low or non-existent. If, on the other hand, DPD is not applied or its effect is mild, e.g., due to computational limitations or energy saving mode, the RX should apply more efficient DPoD. The RX may also need to apply a sufficient degree of DPoD when, for example, a Modulation and Coding Scheme (MCS) with a very high order of modulation is used for scheduling. The RX may also obtain information whether the transmitted signal is a single-layer signal or a multi-layer signal (a sum of multiple signals with different spatial/beamforming configurations) and apply DPoD, e.g., if a single-layer signal was transmitted, and not apply it if a multi-layer signal was transmitted since the received time-domain signal is not a simple scaled copy of the PA output and the attempted non-linearity compensation may not result in desirable fidelity improvement.

With respect to DPoD processing in the downlink, the UE may provide capability information that it can receive/utilize DPoD adaptation guidance info, including supported formats and parameter settings, and that it can dynamically request such guidance info. For reporting these capabilities, the conventional UE capability reporting framework may be used, or the UE may report it within any other control signaling, e.g., as part of RRC configuration procedure using RRC signaling. The capability indication may be frequency-band specific.

The UE may provide preference information on which report format or configuration it currently prefers. The preference may be provided via the UAI framework or other RRC or MAC CE signaling.

The UE may receive from the gNB a configuration for the PA status message that the gNB will transmit. It may specify the message format, PA quality or signal fidelity categories that may be reported, the messaging pattern, etc. This may be provided via dedicated RRC signaling.

The UE may transmit to the gNB a preference or a request for the PA status message transmission. The preference may contain an indication that the message should be transmitted, or at which update rates. The preference may be provided via the UAI framework. The request may convey an indication that a status message transmission (periodic or aperiodic) is desired. It may be signaled via a UCI or MAC CE.

The UE may receive an indication that the configured or requested status message is being transmitted, e.g., via DCI or MAC CE.

Additionally, or instead, the UE may receive the actual PA status message transmission, according to the received or predefined configuration. The UE may then use the status message to configure the DPoD algorithm to apply appropriate compensation.

With respect to DPoD processing of the uplink, the UE may provide capability information that it can transmit status info, and that it can receive dynamic requests for such info.

The UE may receive from the gNB a PA status message configuration that it shall use to transmit such status messages to the gNB. It may specify the message format, PA quality or signal fidelity categories that may be reported, the messaging pattern, etc. This may be provided via dedicated RRC signaling.

The UE may receive an order to transmit the configured PA status message(s), the order signaled via DCI or MAC CE, for example.

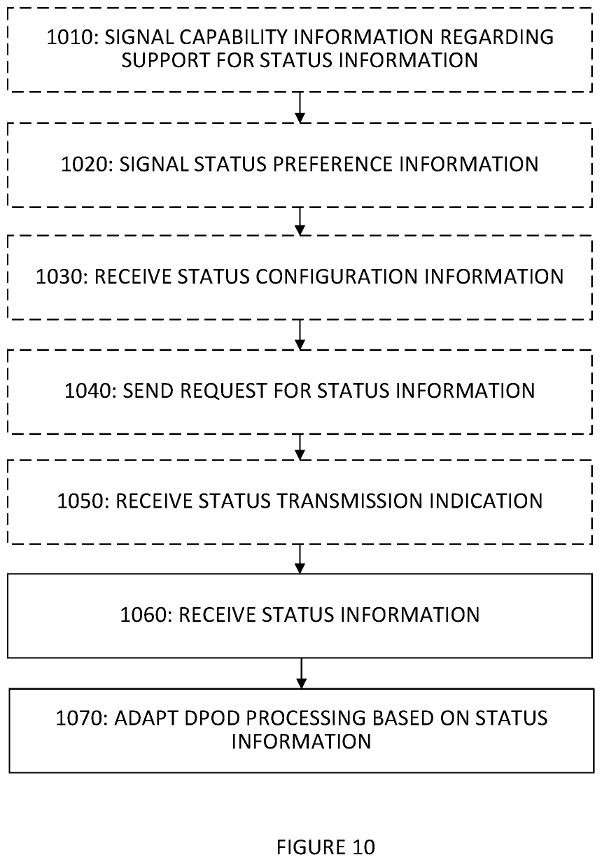

FIG. 10 is a process flow diagram illustrating one example of a method according to several of the techniques described above. It should be understood that the illustrated method is intended to generalize and to encompass many of the specific examples provided above. Thus, where the terminology used below to describe FIG. 10 differs from the terminology above, terms used below should be understood to at least encompass similar or clearly related/analogous terms used above.

The method shown in FIG. 10 is implemented in a first device, which may be, in various instances or embodiments, a UE or base station. The method comprises, as shown at blocks 1060 and 1070, receiving, from a second device, status information relating to non-linearity of transmissions by the second device, and performing or adapting digital post-distortion (DPoD) processing at the first device, based on the status information.

In various embodiments or instances, the status information comprises one or more of: an indication of whether to activate DPoD processing at the first device; an indication of whether digital pre-distortion (DPD) is being used or will be used by the first device; a power-amplifier (PA) non-linear category; PA NL response information; a peak-to-average-power ratio (PAPR) metric; a metric indicative of PA non-linearity; and an indication of whether single-layer or multi-layer transmission is being or will be performed. In some embodiments or instances, at least part of the status information is frequency-band specific in some of these, certain types of status information may be repeated for one or more additional frequency bands.

In some embodiments or instances, the method comprises signaling status capability information to the second device, the status capability information indicating support for one or more of: power amplifier (PA) non-linear (NL) response information; PA mode information indicative of whether digital pre-distortion (DPD) is used; PA NL category; transmitted signal type; and NL sensitivity metric. This is shown at block 1010. The received status information may be in accordance with this status capability information.

In some embodiments or instances, the method comprises signaling status preference information to the second device, as shown at block 1020, the status preference information indicating a preference for one or more of: power amplifier (PA) non-linear (NL) response information; PA mode information indicative of whether digital pre-distortion (DPD) is used; PA NL category; transmitted signal type; NL sensitivity metric; a status report format; and a status report mode. This may be in addition to or instead of the status capability information. The received status information may be in accordance with this status preference information.

In some embodiments or instances, the method comprises receiving status configuration information from the second device, as shown at block 1030. The status configuration information may comprise one or more of: status information type; status report format; status report mode indicative of whether the status report is sent periodically or aperiodically; and status report validity value. In these embodiments or instances, receiving the status information is performed in accordance with the status configuration information.

In some embodiments or instances, the method comprises sending a request for status information to the second device, as shown at block 1040. In these embodiments or instances, the status information may be received in response to the request.

In some embodiments or instances, the method comprises receiving a status transmission indication from the second device, the status transmission indication indicating that periodic status reporting is activated. This is shown at block 1050. In some embodiments or instances, the status information referenced at block 1060 is received at a first instance of the periodic status reporting and the method further comprises receiving second status information updating the status information at a second instance of the periodic status reporting.

In some embodiments or instances, the adapting of the DPoD process, as shown at block 1070, may be based on multiple instances of the status information. In various embodiments or instances, the adapting of the DPoD processing may comprise one or more of: activating or deactivating DPoD operation; adapting DPoD function; adapting one or more DPoD parameters; and adapting fidelity of DPoD operation. Although not shown in FIG. 10, the method may comprise extracting or deriving, from the status information, one or more non-linear characteristics of a transmission from the second device and adapting the DPoD processing based on the extracted or derived one or more non-linear characteristics.

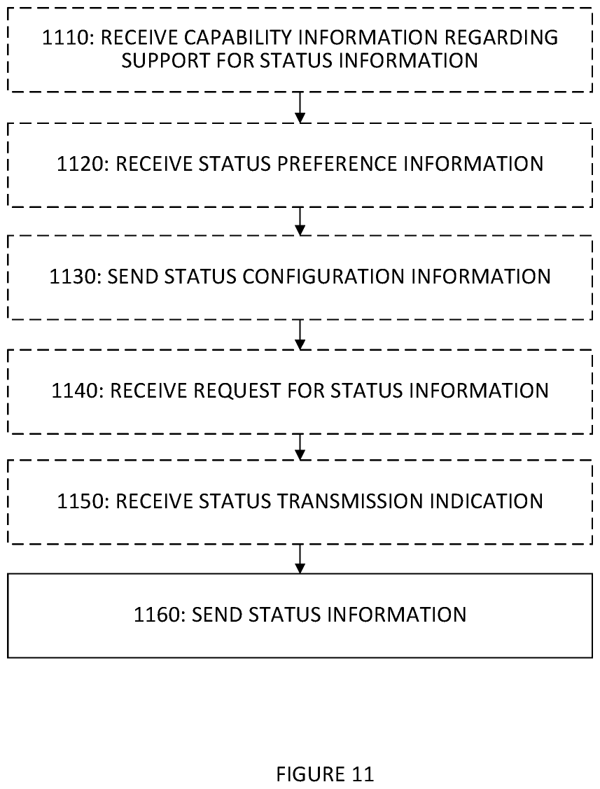

FIG. 11 illustrates another example method as might be performed by a first device. Again, the illustrated method is intended to generalize and to encompass many of the specific examples provided above. Thus, where the terminology used below to describe FIG. 11 differs from the terminology above, terms used below should be understood to at least encompass similar or clearly related/analogous terms used above.

The method shown in FIG. 11 is implemented in a first device, which may be, in various instances or embodiments, a UE or base station. The method comprises, as shown at block 1160, signaling, to a second device, status information relating to non-linearity of transmissions by the first device. In various embodiments or instances, the status information comprises one or more of: an indication of whether to activate DPoD processing at the first device; an indication of whether digital pre-distortion (DPD) is being used or will be used by the first device; a power-amplifier (PA) non-linear category; PA NL response information; a peak-to-average-power ratio (PAPR) metric; a metric indicative of PA non-linearity; and an indication of whether single-layer or multi-layer transmission is being or will be performed.

In some embodiments or instances, at least part of the status information is frequency-band specific—in some of these, certain types of status information may be repeated for one or more additional frequency bands.

In some embodiments or instances, the method comprises receiving status capability information from the second device, the status capability information indicating support for one or more of: power amplifier (PA) non-linear (NL) response information; PA mode information indicative of whether digital pre-distortion (DPD) is used; PA NL category; transmitted signal type; and NL sensitivity metric. This is shown at block 1110. In these embodiments or instances, the method comprises selecting the status information signaled to the second device based on the status capability information.

In some embodiments or instances, the method comprises receiving status preference information from the second device, as shown at block 1120, the status preference information indicating a preference for one or more of: power amplifier (PA) non-linear (NL) response information; PA mode information indicative of whether digital pre-distortion (DPD) is used; PA NL category; transmitted signal type; NL sensitivity metric; a status report format; and a status report mode. This may be in addition to or instead of the status capability information. In these embodiments or instances, the method may comprise selecting the status information signaled to the second device based on the status preference information.

In some embodiments or instances, the method comprises sending status configuration information from the second device, as shown at block 1130. The status configuration information may comprise one or more of: status information type; status report format; status report mode indicative of whether the status report is sent periodically or aperiodically; and status report validity value. In these embodiments or instances, sending the status information is performed in accordance with the status configuration information.

In some embodiments or instances, the method comprises receiving a request for status information to the second device, as shown at block 1140. In these embodiments or instances, the status information may be sent to the second device in response to the request.

In some embodiments or instances, the method may comprise sending a status transmission indication to the second device, the status transmission indication indicating that periodic status reporting is activated. This is shown at block 1150. In some of these embodiments or instances, the status information referred to at block 1160 is signaled at a first instance of the periodic status reporting and the method further comprises signaling second status information, updating the status information, at a second instance of the periodic status reporting.

In either of the methods shown in FIGS. 10 and 11 and described above, the first device may be a UE and the second device a base station, or the first device may be a base station and the second device a UE, or both devices may be UEs, in various embodiments or instances. In some systems, a given node may be capable of carrying out both methods, e.g., to support DPoD processing in both directions for a bi-directional communications link.

In view of the detailed examples and explanation provided above, it will be appreciated that the list below lists core aspects of some embodiments of the presently disclosed techniques, on the UE side, for the downlink and uplink, respectively. These aspects should be interpreted as being consistent with various examples given above.

### UE Actions in the DL

11. A method in a UE for performing DPoD operation using TX non-linearity or other PA status info, the method comprising one or more of:
   signaling a status capability info to a gNB,
   signaling a status preference info to a gNB,
   receiving from the gNB a status configuration info,
   signaling to the gNB a status request,
   receiving from the gNB a status transmission indication, and
   receiving from the gNB a status transmission.
12. + the status capability info comprises support of one or more status types: PA NL response info, PA mode info (DPD on/off), PA NL category, transmitted signal type (single/multi-layer), NL sensitivity metric, etc.
13. + the status configuration info comprises one or more of status type, report format, report mode (aperiodic, periodic, period value, validity value, . . . ) . . .
14. + the status preference info comprises one or more of preferred or required status type, report format, report mode . . .
15. + the status request comprises one of more of activation of periodic report, triggering of aperiodic report, . . .
16. + the status transmission indication comprises an indication that periodic status reporting is activated.
17. + adapting DPoD processing based on the status info received from the gNB, comprising adapting one or more of DPoD function, function parameters, fidelity.

### UE Actions in the UL

11. A method in a UE for providing TX non-linearity or other PA status info to assist DPoD operation in a gNB, the method comprising one or more of:
   signaling status capability info to the gNB,
   receiving from the gNB a status configuration,
   receiving from the gNB a status request, and
   signaling to the gNB a status information.
12. + the status capability info comprises support of one or more status types: PA NL response info, PA mode info (DPD on/off), PA NL category, transmitted signal type (single/multi-layer), NL sensitivity metric. etc.
13. + the status request info comprises one or more of request to provide status info once, or periodically,
14. + the configuration info comprises one or more of status type, report format, report mode (aperiodic, periodic, period value, validity value, . . . ) . . .

Note that gNB (base station) signaling steps for DL and UE are direct counterparts to the UE embodiments summarized immediately above.

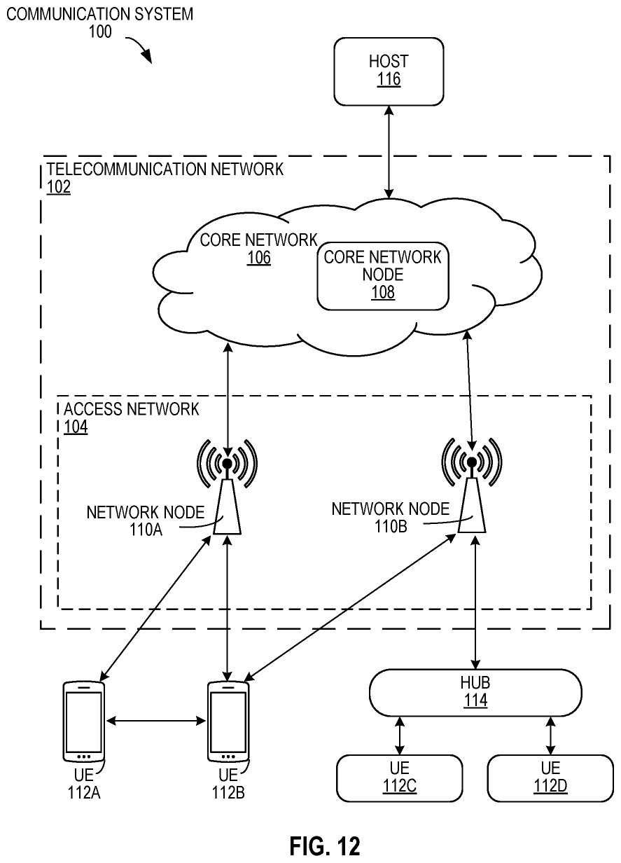

FIG. 12 shows an example of a communication system 100 in accordance with some embodiments. The techniques and apparatuses described above may be implemented in such system, or variations thereof. In this example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 102 includes one or more Open-RAN (ORAN) network nodes. An ORAN network node is a node in the telecommunication network 102 that supports an ORAN specification (e.g., a specification published by the O-RAN Alliance, or any similar organization) and may operate alone or together with other nodes to implement one or more functionalities of any node in the telecommunication network 102, including one or more network nodes 110 and/or core network nodes 108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub-that is, a device which is capable of operating to route communications between the UEs and network node 110b, but which is additionally capable of operating as a communication start and/or end point for certain data channels.

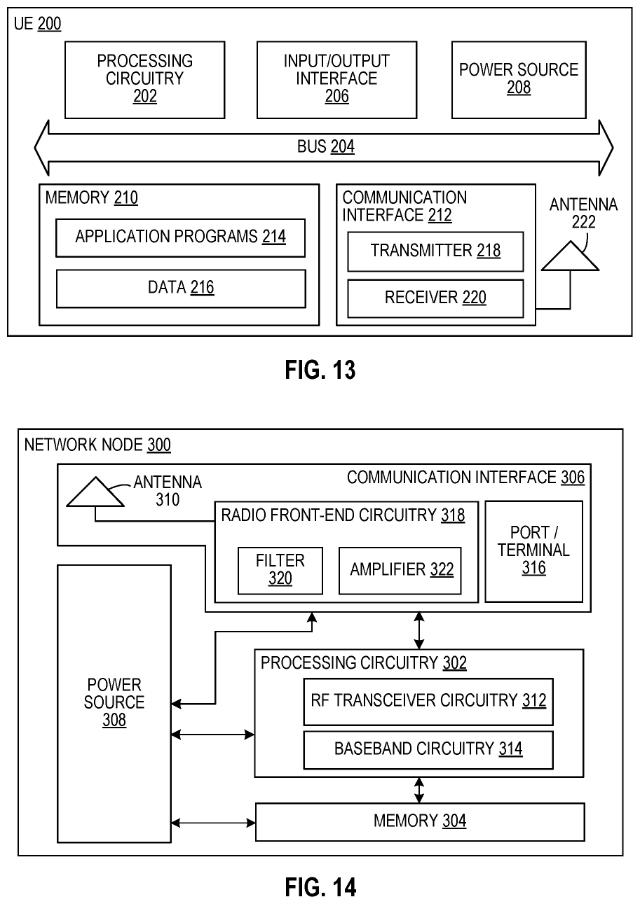

FIG. 13 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 2. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 14 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-44. (canceled)

45. A method, in a first device, the method comprising:
sending, to a second device, capability information indicating the first device's ability to perform digital post-distortion (DPoD) processing to reduce non-linear distortion in signals received by the first device.

46. The method of example claim 45, wherein the capability information comprises at least one of:
one or more metrics indicating an extent of and/or characteristic of non-linear distortion the first device can compensate with DPoD processing;
an indication of a preference for a distortion level, a distortion shape or function, and/or other characteristic for non-linear distortion the first device can compensate with DPoD processing.
an indication that the first device can receive and utilize a non-linearity estimation reference signal (NLE-RS) for DPoD processing.
an indication that the first device can receive and utilize power amplifier (PA) response information for DPoD processing.

47. The method of claim 45, wherein at least part of the capability information is sent using Radio Resource Control (RRC) signaling and wherein at least part of the capability information is specific to a frequency band.

48. The method of claim 45, wherein the method comprises receiving a request for capability information indicating the first device's ability to perform DPoD processing and wherein said sending is in response to said request.

49. The method of claim 45, wherein the method comprises:
dynamically signaling, to the second device, an indication of DPoD processing use.

50. The method of claim 49, wherein the indication of DPoD processing use identifies one of two or more predetermined DPoD configurations.

51. The method of claim 45, wherein the method further comprises:
receiving, from the second device or a third device, configuration information indicating that the first device is to apply DPoD processing to reception of one or more signals transmitted to the first device.

52. The method of claim 51, wherein the configuration information indicates one or more channels, one or more time intervals, one or more frequency bands, and/or one or more transmission types to which the first device is to apply the DPoD processing.

53. The method of claim 51, wherein at least part of the configuration information is received via Radio Resource Control signaling.

54. The method of claim 51, wherein at least part of the configuration information is received via dynamic signaling.

55. The method of claim 45, further comprising receiving a signal and performing DPoD processing on the signal.

56. The method of claim 45, wherein the method further comprises receiving, from the second device, at least one of:
an indication that the second device can transmit a non-linearity estimation reference signal (NLE-RS);
an indication that the second device can send power amplifier (PA) response information;
power amplifier (PA) response information;
an indication that the second device can adapt its transmission of signals to the first device based on DPoD capabilities of the first device.

57. A method, in a first device, the method comprising:
receiving, from a second device, capability information indicating the second device's ability to perform digital post-distortion (DPoD) processing to reduce non-linear distortion in signals received by the second device.

58. The method of claim 57, wherein the method further comprises adapting one or more transmissions to the second device, based on the capability information.

59. The method of claim 57, wherein the method comprises sending, to the second device, a request for capability information indicating the second device's ability to perform DPoD processing, and wherein said receiving is in response to said request.

60. The method of claim 57, wherein the method comprises:
receiving, from the second device, an indication of DPoD processing use; and
adapting one or more transmissions sent to the second device based on said indication of DPoD processing use.

61. The method of claim 45, wherein the first device is a user equipment (UE) and the second device is a base station, or wherein the first device is a base station and the second device is a UE.

62. An apparatus comprising receiver circuitry, transmitter circuitry, and processing circuitry operatively coupled to the receiver circuitry and transmitter circuitry, wherein the processing circuitry is configured to use the receiver circuitry and/or transmitter circuitry to carry out a method according to claim 45.

63. A network node comprising the apparatus of claim 62.

64. A user equipment, UE, comprising the apparatus of claim 62.
